(19) United States
(12) Patent Application Publication
(10) Pub. No.: US 2003/0166348 A1
(43) Pub. Date: Sep. 4, 2003

(54) Contact guide retention apparatus

(76) Inventors: Galen M. Martin, Camp Hill, PA (US); Keith R. Foltz, Oberlin, PA (US)

Correspondence Address: Tyco Electronics Corporation, Suite 450, 4550 New Linden Hill Road, Wilmington, DE, 19808-2952, US

(21) Appl. No.: 10/087,030

(22) Filed: Mar. 1, 2002

(51) Int. Cl. H01R 12/00

(52) U.S. Cl. 439/79

(57) ABSTRACT

An electrical connector configured for connection to a substrate includes a housing which carries a plurality of electrical contacts. Each contact has a contact interface interconnectable with a reciprocal contact interface carried by a substrate. A contact guide has a plurality of apertures positioned to align and mate with the contact interfaces of the contacts. The housing includes a single locking mechanism configured to mate with both the contact guide and the substrate for securing the contact guide and the substrate to the housing.

### BACKGROUND OF THE INVENTION

The quest to make electronic devices ever more compact has sparked a related desire to produce compact electrical connectors. Space is at a premium on these electrical connectors. Thus the ability to shrink, eliminate, or increase the efficiency of any component is highly desirable.

Electrical contacts may be bent or misaligned during shipping or handling. If the contacts are not aligned properly, the electrical connector may be destroyed as it is connected, often robotically, with other components. As a result, a contact guide is often used to maintain proper alignment of the electrical contacts of the electrical connector prior to the connector being mated with a substrate, such as a printed circuit board (PCB). The contact guide contains holes that allow the contacts to pass through. In this way the contact guide supports and protects the contacts, keeping them in proper alignment.

Typically, the connectors include one feature for securing the contact guide to the electrical connector and another feature for securing the connector to a substrate. In view of the emphasis on size reduction, it would be desirable to save space on the electrical connector by devising a single feature for securing both the contact guide and the substrate to the electrical connector.

### BRIEF SUMMARY OF THE INVENTION

According to certain aspects of an embodiment of the present invention, an electrical connector configured for connection to a substrate includes a housing that carries a plurality of electrical contacts. Each contact has a contact interface interconnectable with a reciprocal contact interface carried by a substrate. A contact guide has a plurality of apertures positioned to receive the contact interfaces of the contacts. The housing includes a single locking mechanism configured to mate with both the contact guide and the substrate for securing the contact guide and the substrate to the housing.

The locking mechanism may consist of a post extending from the housing. The post is configured to mate with reciprocal apertures formed in both the contact guide and the substrate for securing the contact guide and the substrate to the housing. The post may be sized to form an interference fit with the reciprocal aperture in the contact guide, so that the contact guide can be press fit onto the post. For this purpose, the post may include an enlarged diameter portion sized to form an interference fit with the reciprocal aperture formed in the contact guide.

The post may be configured to snap into the reciprocal aperture in the substrate. For this purpose, the post may consist of a bifurcated post having first and second opposed legs, which are compressible towards one another for insertion into the reciprocal aperture in the substrate. At least one of the opposed legs includes a locking feature configured to lockingly engage with the substrate when the opposed legs are inserted into the reciprocal aperture in the substrate.

### BRIEF DESCRIPTION OF SEVERAL VIEWS OF THE DRAWINGS

FIG. 1 is an exploded bottom perspective view of an electrical connector in accordance with certain aspects of an embodiment of the present invention, shown in combination with a substrate.

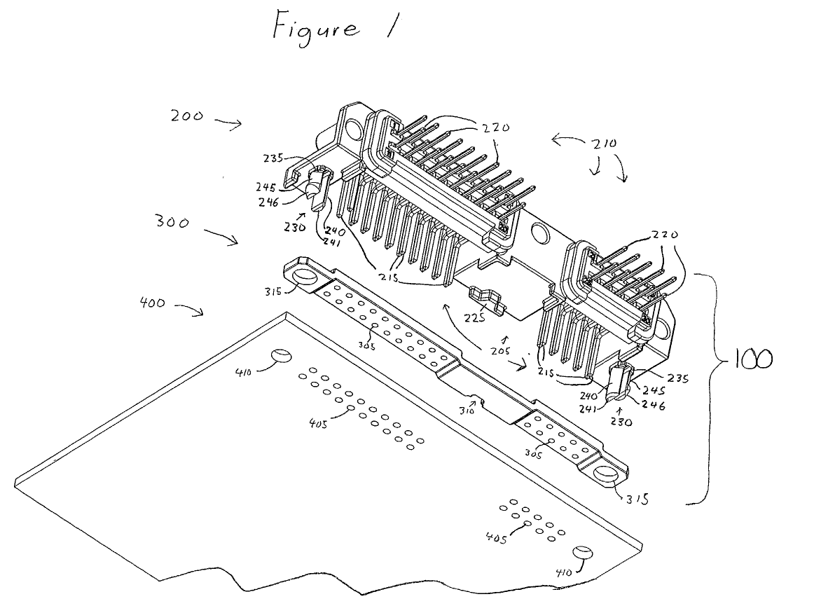

FIG. 2 is a partial exploded top perspective view of the connector of FIG. 1.

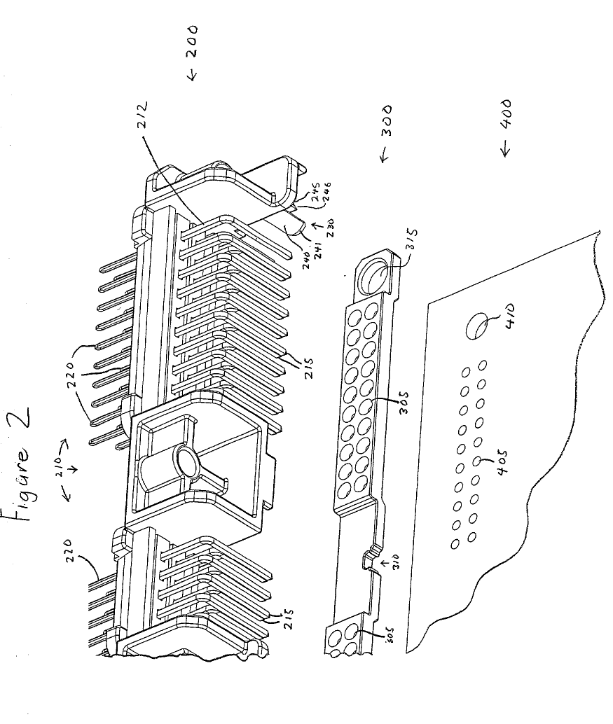

FIG. 3 is a front bottom perspective view of the connector of FIG. 1, showing the housing assembled to the contact guide.

FIG. 4 is an enlarged, partial perspective view of the connector of FIG. 1.

FIG. 5 is a top bottom perspective view of the connector of FIG. 1, showing the housing assembled to the contact guide.

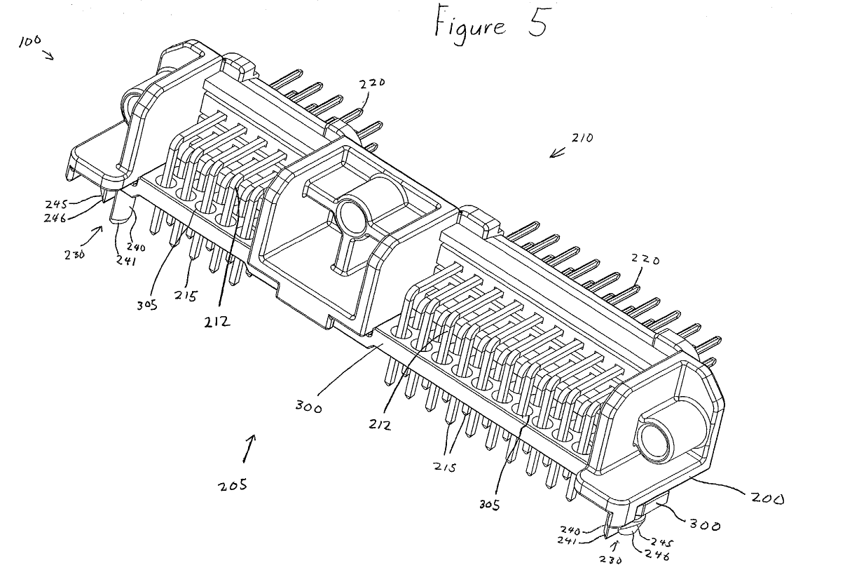

FIG. 6 is a partial bottom perspective view illustrating the assembly of FIG. 3 connected to a substrate.

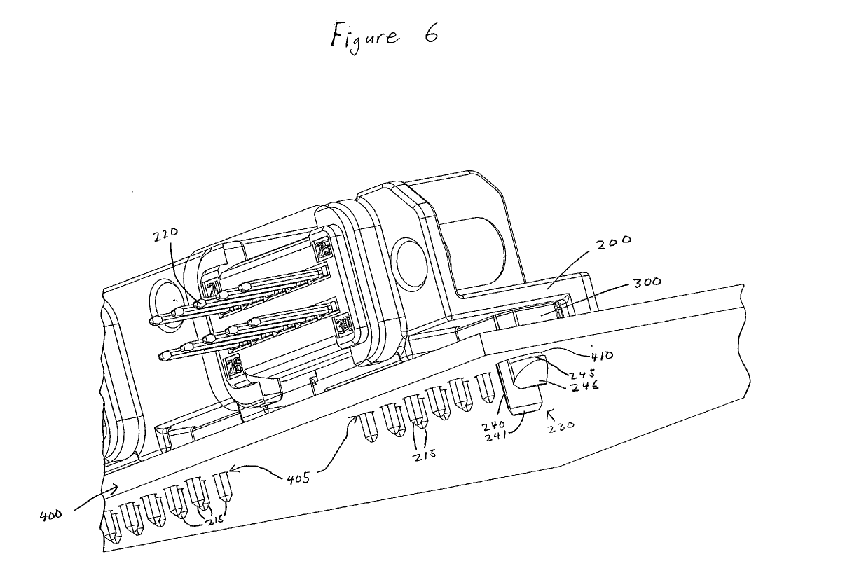

FIG. 7 is a top partial perspective view illustrating the assembly of FIG. 3 connected to a substrate.

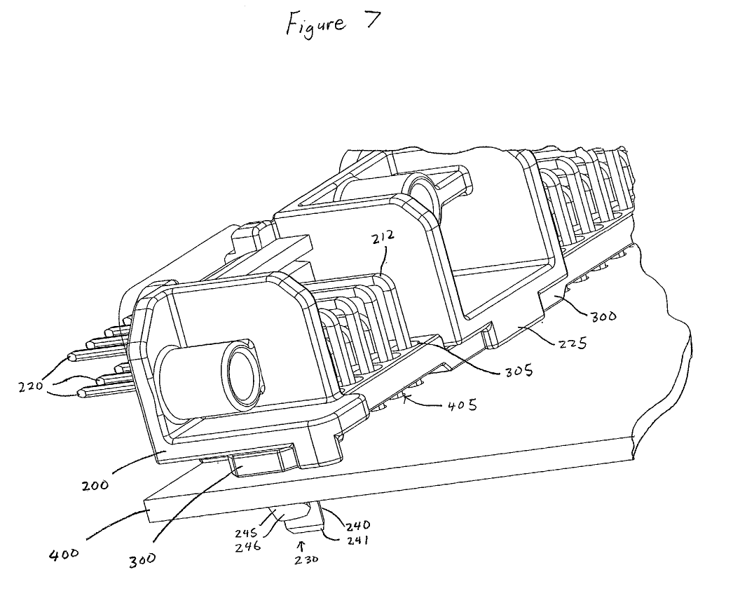

FIG. 8 is a cross-sectional view along line 8-8 of FIG. 9.

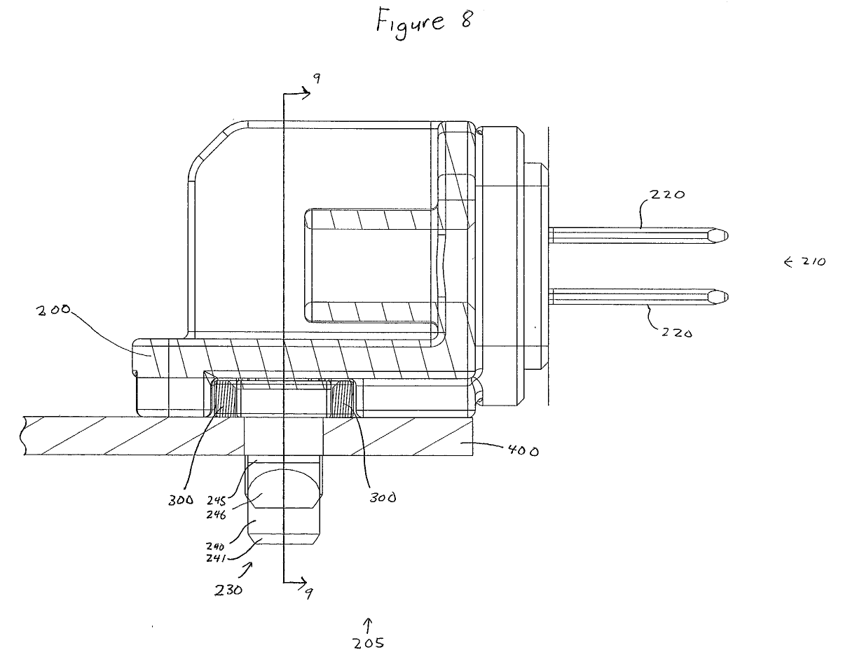

FIG. 9 is a cross-sectional view along line 9-9 of FIG. 8.

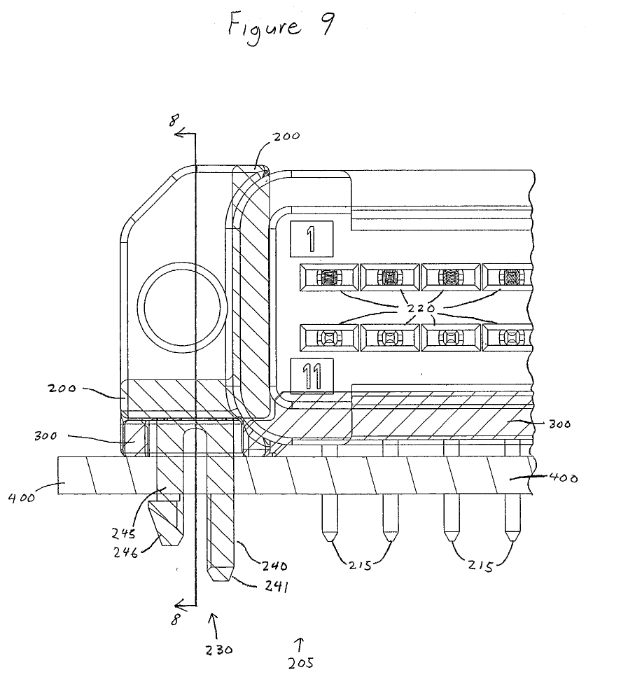

The foregoing summary, as well as the following detailed description of the preferred embodiments of the present invention, will be better understood when read in conjunction with the appended drawings. For the purpose of illustrating the preferred embodiments of the present invention, there is shown in the drawings, embodiments that are presently preferred. It should be understood, however, that the present invention is not limited to the arrangements and instrumentality shown in the attached drawings.

### DETAILED DESCRIPTION OF THE INVENTION

Referring to the drawings, an electrical connector 100 according to certain aspects of a specific embodiment of the present invention includes a housing 200 and a contact guide 300. The housing 200 includes a substrate end 205 matable to a substrate 400 and a connector end 210 matable to one or more other electrical connectors (not shown) for interconnecting the other electrical connector(s) to the substrate 400. The electrical connector 100 contains a plurality of electrical contacts 212. The electrical contacts 212 extend between the substrate end 205 and the connector end 210 of the housing 200. The connectors 100 terminate in contact interfaces 215, 220 that are matable with reciprocal interfaces 405 in the substrate 400 and in other connector(s), respectively. Specifically, each contact 212 includes a substrate interface 215 extending from the substrate side 205 of the housing 200 and a connector interface 220 extending from the connector side 210 of the housing 200. In the illustrated embodiment, the interfaces 215, 220 are in the form of male pin connectors. The substrate interfaces 215 are configured to align and mate with through holes 405 formed on the substrate 400. Similarly, the connector interfaces 220 can mate with female pin-receiving interfaces carried by one or more other electrical connectors. It will be appreciated, however, that the contact interfaces 215, 220 could take other forms, such as blades, or connect by various means such as soldering or press fitting, without departing from the scope of the appended claims.

The illustrated connector 100 is in the form of a right angle connector wherein the substrate end 205 and the substrate interfaces 215 extend perpendicular to the connector end 210 and the connector interfaces 220. Therefore, each contact 212 is bent into a generally L-shape between its substrate interfaces 215 and connector interfaces 220. It will be appreciated that the housing 200 and contacts 212 can assume other shapes and configurations without departing from the scope of the present invention. For example, the interfaces 215, 220 could extend in opposite directions or at some angle other than 90°.

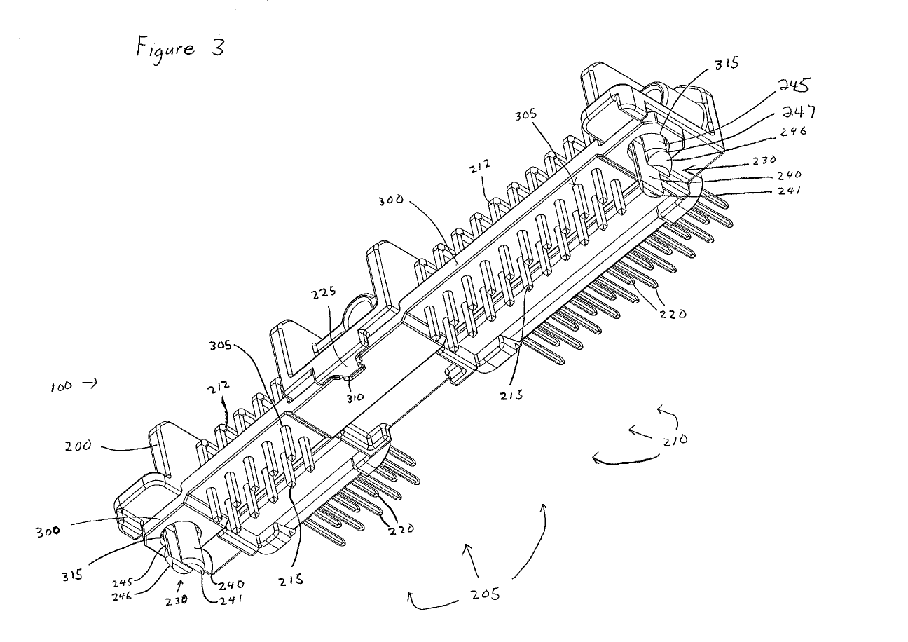

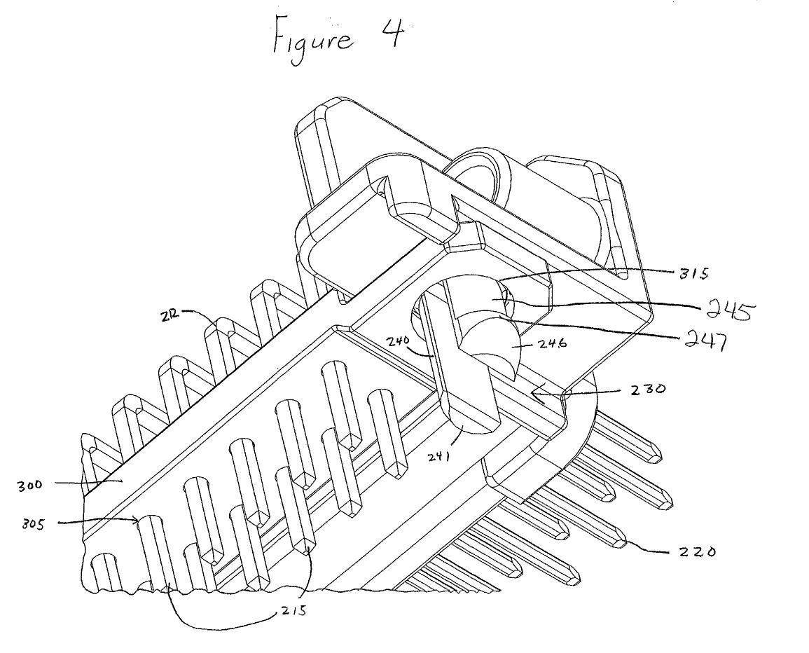

The contact guide 300 is configured to slide into place over the substrate end 205 of the housing 200. The contact guide 300 includes a plurality of contact receiving apertures 305 that are sized and positioned to slide over the contact interfaces 215 when the guide 300 is mounted on the substrate end 205 of the housing 200. The contact guide 300 is slid downwardly over the substrate interfaces 215 until the inner face of the contact guide 300 abuts against the housing 200. A cut out or groove 310 on the contact guide 300 mates with a reciprocal protrusion 225 on the housing 200 to properly position and align the contact guide 300. Once the contact guide 300 is installed, the substrate interfaces 215 extend distally beyond the outer face of the contact guide 300 so they can mate with the reciprocal interfaces, e.g. through holes 405, in the substrate 400. (See, e.g., FIGS. 3 and 4).

When installed, the contact guide 300 maintains proper alignment of the substrate contact interfaces 215 prior to the connector 100 being mated with a substrate 400, such as a printed circuit board (PCB). The contact guide 300 supports, protects, and aligns the substrate interfaces 215 by allowing the interfaces 215 to pass through the contact guide apertures 305. Such aid in alignment is beneficial because the electrical contact interfaces 215 may otherwise be bent or misaligned during shipping or handling. If the substrate interfaces 215 are not properly aligned, the electrical connector 200 may be destroyed as it is connected, often robotically, with the substrate.

The electrical connector 100 includes a locking mechanism, which functions to secure the housing 200 to both the contact guide 300 and the substrate 400. In the illustrated embodiment, the locking mechanism includes first and second posts 230 that extend from the substrate end 205 of the housing 200. Each post 230 is configured to mate with a reciprocal aperture 315 in the contact guide 300, and also with a reciprocal aperture 410 in the substrate 400.

In the illustrated embodiment, the posts 230 are integrally formed with the housing 200. Alternatively, the posts 230 can be mounted to the housing 200 as separate unitary structures affixed to the housing in any of several manners, such as through adhesives, glue, snaps, interference fit, screws, sonic welding or other fastener means. In such instances the posts 230 may be formed of the same or a different material than the housing 200. For example, the housing 200 can be formed of plastic and the posts 230 can be formed of metal.

In the illustrated embodiment, the posts 230 are configured to be press fit into the apertures 315 in the contact guide 300. For this purpose, each post 230 includes an enlarged portion or rib 235 at its base. The enlarged rib 235 is sized and shaped to form an interference fit with the reciprocal aperture 315 in the contact guide 300 so that the contact guide 300 can be press fit onto the post 230.

In the illustrated embodiment, the posts 230 are configured to snap fit into the apertures 410 in the substrate 400. For this purpose, each post 230 is bifurcated into a first leg 240 and a second leg 245. The legs 240, 245 are compressible towards each other to allow the post 230 to be inserted into a reciprocal aperture 410 in the substrate 400. The distal ends 241, 246 of the legs 240, 245 are beveled to ease their insertion into the substrate aperture 410. The distal end 246 of the second leg 245 includes a locking feature 247 on its distal end to allow the post 230 to snap fit into the aperture 410. (See FIGS. 3 and 4). As the post 230 is inserted into the substrate aperture 410, the edges of the aperture 410 engage the distal ends 241, 246 of the legs 240, 245, compressing the legs 240, 245 inward. The side wall of the aperture 410 presses against the distal ends 241, 246, keeping the legs 240, 245 compressed inward until their distal ends 241, 246 pass through the aperture 410. Once the distal ends 241, 246 pass through the aperture 410, the legs 240, 245 snap outwardly to secure the housing 200 to the substrate 400. The locking feature 247 on the second leg 245 engages against the bottom face of the substrate 400 to lock the post 230 into position. It will be appreciated that locking fingers may exist on either or both post legs, without departing from the scope of the appended claims.

The locking mechanism functions to simultaneously secure the housing 200 to both the contact guide 300 and the substrate 400. In the illustrated embodiment, the locking feature consists of two posts 230, as described above. However, the number of posts and the specific design of the post can be varied without departing from the scope of the invention. For example, the posts 230 could be configured to be press fit into both the contact guide 300 in the substrate 400. In such a design, the posts could be solid, instead of bifurcated, and could include two sections of differing diameters. One of the sections, e.g., the lower section, would have a larger diameter sized to press fit into aperture 315 in the substrate 300. The other section, e.g., the upper section, would have a smaller diameter sized to press fit with the aperture 410 in the substrate 400. Alternatively, the posts 230 could be configured to form a snap fit with both the contact guide 300 and the substrate 400, in a manner analogous to that described above. As still another alternative, the pin guide can be sonically welded to the housing, e.g. to the posts 230.

While the invention has been described with reference to a preferred embodiment, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An electrical connector of the type which is connectable to a substrate, comprising:
a housing;
a plurality of electrical contacts carried by the housing, each contact having contact interface interconnectable with a reciprocal contact interface carried by a substrate;
a contact guide having a plurality of apertures positioned to align and mate with the contact interfaces of the contacts; and
the housing including locking mechanism configured to mate with both the contact guide and the substrate for securing the contact guide and the substrate to the housing.

2. An electrical connector as set forth in claim 1, wherein the locking mechanism comprises at least one post extending from the housing and being configured to mate with reciprocal apertures formed in both the contact guide and the substrate for securing the contact guide and the substrate to the housing.

3. An electrical connector as set forth in claim 2, wherein the at least one post is sized to form an interference fit with the reciprocal aperture in the contact guide.

4. An electrical connector as set forth in claim 3, wherein the at least one post includes an enlarged diameter portion sized to form an interference fit with the reciprocal aperture formed in the contact guide.

5. An electrical connector as set forth in claim 2, wherein the post is adapted to snap into the reciprocal aperture in the substrate.

6. An electrical connector as set forth in claim 2, wherein the post comprises a bifurcated post having first and second opposed legs which are compressible towards one another for insertion into the reciprocal aperture in the substrate.

7. An electrical connector as set forth in claim 6, wherein at least one of the opposed legs includes a locking feature configured to lockingly engage with the substrate when the opposed legs are inserted into the reciprocal aperture in the substrate.

8. An electrical connector as set forth in claim 1, wherein the contact interfaces comprise male pin connectors.

9. An electrical connector, comprising:
a housing having a substrate end matable with a substrate and a connector end matable with a second electrical connector;
a plurality of electrical contacts carried by the housing, each contact having a first contact interface positioned in the substrate end of the housing for interconnection with a reciprocal contact interface carried by the substrate and a second contact interface positioned in the connector end of the housing for interconnection with a reciprocal contact interface carried by the second electrical connector;
a contact guide configured to mate with the substrate end of the housing, the contact guide including a plurality of apertures positioned to matingly align with the first contact interfaces; and
a single connection means for securing the housing to both the contact guide and to the substrate.

10. An electrical connector as set forth in claim 9, wherein the first contact interface is oriented perpendicular to the second contact interface.

11. An electrical connector as set forth in claim 9, wherein the single connection means comprises a post extending from the substrate side of the housing, the post being configured to mate with a reciprocal aperture formed on the contact guide and a reciprocal aperture formed on the substrate.

12. An electrical connector as set forth in claim 11, wherein the post has an enlarged portion sized to form an interference fit with the reciprocal aperture in the contact guide.

13. An electrical connector as set forth in claim 11, wherein the post is adapted to snap into the reciprocal aperture in the substrate.

14. An electrical connector as set forth in claim 11, wherein the post has first and second opposed legs that are compressible towards one another to allow the post to be inserted into the reciprocal aperture in the substrate.

15. An electrical connector as set forth in claim 14, wherein at least one of the opposed legs includes a locking feature configured to lockingly engage with the substrate when the first and second legs are inserted into the reciprocal aperture in the substrate.

16. An electrical connector as set forth in claim 9, wherein the first contact interfaces comprise male pin connectors.

17. An electrical connector, comprising:
a housing having a substrate end matable with a substrate and a connector end matable with a second electrical connector;
a plurality of electrical contacts carried by the housing, each contact having a first contact interface positioned in the substrate end of the housing for interconnection with a reciprocal contact interface carried by the substrate and a second contact interface positioned in the connector end of the housing for interconnection with a reciprocal contact interface carried by the second electrical connector;
a contact guide configured to mate with the substrate end of the housing, the contact guide including a plurality of apertures positioned to matingly align with the first contact interfaces; and
first and second posts extending from the housing, each of the posts being configured to mate with a reciprocal aperture formed on the contact guide and a reciprocal aperture formed on the substrate for securing the housing to the contact guide and the substrate, respectively.

18. An electrical connector as set forth in claim 17, wherein the posts have an enlarged portion sized to form an interference fit with the reciprocal apertures in the contact guide.

19. An electrical connector as set forth in claim 17, wherein the posts are adapted to snap into the reciprocal apertures in the substrate.

20. An electrical connector as set forth in claim 17, wherein each post has first and second opposed legs that are compressible towards one another to allow the post to be inserted into a reciprocal aperture in the substrate.

21. An electrical connector as set forth in claim 20, wherein at least one of the opposed legs of each pair includes a locking feature configured to lockingly engage with the substrate when the first and second legs are inserted into a reciprocal aperture in the substrate.

22. An electrical connector as set forth in claim 17, wherein the first and second contact interfaces comprise male pin connectors.

23. An electrical connector as set forth in claim 17, wherein the first contact interface is oriented perpendicular to the second contact interface.
